(19) United States
(12) Patent Application Publication
(10) Pub. No.: US 2003/0059948 A1
(43) Pub. Date: Mar. 27, 2003

(54) Spectroscopic test system based on microcapillaries

(75) Inventors: Karlheinz Hildenbrand, Krefeld (DE); Ingmar Dorn, Koln (DE); Edgar Diessel, Koln (DE); Frank Lison, Gauting (DE)

Correspondence Address: KURT BRISCOE, NORRIS, MCLAUGHLIN & MARCUS, P.A., 220 EAST 42ND STREET, 30TH FLOOR, NEW YORK, NY, 10017, US

(73) Assignee: Bayer Aktiengesellschaft, Leverkusen (DE)

(21) Appl. No.: 10/202,332

(22) Filed: Jul. 24, 2002

(30) Foreign Application Priority Data
Aug. 24, 2001 (DE) 10140680.0

(51) Int. Cl. G01N 21/63; G01N 21/65

(52) U.S. Cl. 436/171; 436/164; 436/165; 435/14; 356/51; 356/300; 356/301; 422/82.05

(57) ABSTRACT

The invention relates to the method of using spectroscopic methods for determining analytes in a sample and also a test system for qualitative and/or quantitative determination of one or more analytes in a liquid sample.

The invention relates to the method of using spectroscopic methods for determining analytes in a sample and also a test system for qualitative and/or quantitative determination of one or more analytes in a liquid sample.

Test systems for self diagnosis in the home user sector, in particular for blood sugar, have been an established state of the art for many years.

Nevertheless, continuous further development of the existing products is desirable, with the aim of achieving further improvements in accuracy and reproducibility and in particular handling and user-friendliness. Biosensors based on electrochemical detection reactions and membrane-based test strips where colour reactions are evaluated reflectometrically are state of the art.

With regard to user-friendliness, biosensors which sip in the patient's blood, in particular, rate favourably.

In order to obtain reproducible results, the complete electrode compartment of the electrochemical sensors (see e.g. U.S. Pat. No. 5,759,364) must be covered with blood, for which at least 3 μl of blood or more are generally required in the products known to date.

For membrane-based test strip systems (e.g. U.S. No. Pat. 5,453,360) which are evaluated reflectometrically, even larger amounts of blood are generally required.

With regard to reproducibility and precision, uniform application of the biochemical reagent system into the test element is particularly decisive, in addition to the consistency of the sensor geometry and the membrane morphology.

The electrochemical biosensors involve the application of an enzyme/mediator formulation, for example by screen printing or micropipetting, to the sensor electrode compartment.

Colorimetric test strip systems involve microporous membranes being impregnated or coated with enzyme/indicator formulations.

Microcapillaries in numerous variations in the form of columns of chromatography, in particular of gas chromatography (GC) and capillary electrophoresis (CE), are known (“Making and Manipulating Capillary Columns for Gas Chromatography” by Kurt Grob, Huethig Verlag, 1986) and are referred to hereinafter as microcapillary columns. Microcapillary columns may be manufactured in lengths of up to 50 or even 100 m with high reproducibility.

German patent application 100 08 906 which is due to be published discloses that clear advances may be achieved with regard to the above target criteria on the basis of microcapillary columns in the colorimetric determination of analytes such as glucose in liquid samples such as blood. However, the colorimetric determination requires the integration of a chromogenic enzymatic reagent system into the interior of the microcapillary column. This requires a relatively complex process associated with considerable costs for the enzymatic reagent system. Further, such chromogenic test systems may only be used for one analyte. For example, a glucose oxidase reagent system may only be used once to detect glucose.

It is an object of the invention to enable the determination of analytes in liquid samples while utilizing the advantages of microcapillaries without an enzymatic reagent system being necessary, i.e. reagent lessly (without analytical auxiliary reagents).

The invention provides the method of usings pectroscopic methods for qualitative and/or quantitative determination of one or more analytes in a sample taken up by a microcapillary.

The invention also provides a test system for qualitative and/or quantitative determination of one or more analytes in a liquid sample wherein the sample is taken up by a microcapillary and the analyte or analytes are determined by a spectroscopic method.

According to the invention, the sample liquid, for example whole blood or interstitial tissue fluid, is sipped in by capillary forces into a microcapillary, as used, for example, in chromatography. In addition to the aspect of the small sample volumes, this also has the advantage that the sample liquid cannot come into contact with binders or adhesives which are customarily required for preparing conventional test strips or biosensor systems.

Useful spectroscopic methods are well known to those skilled in the art and are selected in a suitable manner while taking into account the properties of the analyte and liquid sample. Preferred spectroscopic methods include infrared (IR) and Raman spectroscopy. More preferred spectroscopic methods for the infrared region include the near infrared (NIR) and the middle infrared region (MIR). The adaptation of both methods to the analysis of very small sample volumes in microcapillaries may be achieved, in addition to the application of standard geometries, by various further useful embodiments: e.g. surface-sensitive methods such as attenuated total reflection (ATR), optical waveguides in the form of optical fibres or planar-optical light waveguides, optical excitation of very small probe volumes with optical near field methods (SNOM), in particular for Raman spectroscopy: surface-enhanced Raman spectroscopy (SERS) or nonlinear Raman spectroscopy, e.g. coherent anti-Stokes Raman spectroscopy (CARS), confocal geometries for reducing background signals. The surface-sensitive methods such as the IR-spectroscopic ATR technology are particularly useful for samples which are unsuitable for transmission measurements.

The dimensions and material properties of the microcapillaries used according to the invention should be chosen so that they sip in an essentially aqueous sampling liquid by capillary forces. The sipped in sample volume, in particular for microcapillaries of length about 1 cm, is preferably smaller than 3 μl, more preferably smaller than 1 μl, most preferably 0.5 μl or smaller.

Useful microcapillaries are in particular known from gas chromatography (GC) and capillary electrophoresis (CE). Such microcapillary columns fulfil the requirements set according to the invention both with regard to capillary geometry and the qualities of the capillary interior substantially or even completely.

The microcapillaries used according to the invention preferably have a round cross section. The internal diameter of the microcapillaries is preferably less than 500 μm, more preferably less than 250 μm, most preferably 10 μm to 100 μm.

The length of the microcapillaries used is preferably up to 2 cm, more preferably up to 1 cm, most preferably about 0.5 cm.

For the purposes of the invention, GC or CE columns whose dimensions are customarily such that even very small liquid sample quantities, for example 0.5 μl of blood or interstitial tissue fluid, are sufficient for a function test using capillary lengths of 1 cm or less, have proven to be useful.

Owing to the small sample volumes, the microcapillaries according to the invention also fulfil the requirements of “minimal invasive” test kits, which are said to be especially advantageous, in particular to minimize pain, for the patient.

The microcapillaries comprise suitable material which is inert under the particular conditions and is transparent to the radiation of the spectroscopic method. Examples include quartz glass and normal glass.

Microcapillaries preferably carry an internal coating which is also referred to in chromatography as the stationary phase. This coating may comprise numerous materials which are in principle known for available GC columns. Useful coatings for the microcapillary test systems according to the invention include hydrophilic and/or polar coating materials, e.g. polyethylene glycols having various molecular weights (Carbowax®), polyethylene glycol derivatives, for example Carbowax® 4000 monostearate, and cyanopropylpolysiloxane.

Regarding application of the stationary phases (internal coating of the microcapillaries), reference may be made to the standard procedures known for GC columns. As described in the above-mentioned literature (K. Grob, 1986), there are in principle two possible methods. These are static coating and dynamic coating. These processes allow microcapillaries of up to 50 or even 100 m in length to be coated. The polymers in the stationary phases may also be covalently bonded to the surface of the quartz column, as described in the above-mentioned literature.

The conventional microcapillary columns customarily comprise the already mentioned quartz (fused silica). The previously used glass columns have become significantly less important in chromatography, but owing to their outstanding transparency are in fact of importance for test systems according to the invention.

The quartz columns are generally coated on the outside with a yellow/brown high temperature-stable polyimide layer. This eliminates the brittleness of quartz capillaries and easily manageable flexible microcapillary columns are obtained which, with regard to production and further processing, may be handled as a roll material.

The test systems of the invention require sufficient transparency for the radiation of the spectroscopic method. When the coloured polyimide layer disrupts the spectroscopic analysis, transparent, colourless polymers, e.g. polysiloxanes, acrylpolymers, polyvinyl acetate, polycarbonate, polyamide or polyether polysulphone, may be used instead. If desired, the disruptive layer may be removed in the appropriate area of the microcapillary for the analysis, for example by laser ablation.

The essential requirement for microcapillaries as a fundamental component for the test kits of the invention is their ability to sip in whole blood, interstitial tissue fluid or other sample liquids, with the aid of capillary forces.

Surprisingly, it was found that microcapillaries having hydrophilic and/or polar coatings, e.g. polyethylene glycol (Carbowax®) or having what are known as polar stationary phases, e.g. cyanopropylpolysiloxane, sip in sample liquids such as blood or interstitial tissue fluid outstandingly, i.e. hydrophilic and/or polar coatings favour the aspiration of the sample liquid by capillary forces, while microcapillaries modified by hydrophobic coatings (e.g. polysiloxane-modified) do not show this property.

However, the latter microcapillary types may be modified for this purpose by treatments with certain surfactants.

Useful surfactants include ionic surfactants, for example SDS, zwitterionic surfactants, for example phospholipids, and nonionic surfactants, for example Pluronic® or fluorosurfactants (for example Bayowet FT 219®).

Such surfactants, with regard to further optimization of the sip-in performance, may also be present in or on hydrophilic coatings mentioned, e.g. Carbowax®.

The sample liquid is customarily an essentially aqueous liquid, in particular a body fluid. Examples include urine, interstitial tissue fluid and blood.

Examples of typical analytes which may be determined include glucose, bilirubin, ketones, pH, proteins and cholesterol.

While the conventional colorimetric test systems (test strips, biosensors) only allow one determination per test element, reagent less elements of the test systems according to the invention allow simultaneous or sequential multiple determination, for example glucose and cholesterol tests, within one test element.

In a particular embodiment of the invention, the liquid sample is blood or interstitial tissue fluid and the analyte glucose.

The spectroscopic measurement is customarily carried out by transmission through the microcapillary wall.

After sip-in of the sample liquid, for example interstitial tissue fluid, the qualitative and/or quantitative determination of the analyte, for example glucose, is carried out by spectroscopic means, preferably immediately in the microcapillary, which effectively functions as a cuvette.

With regard to practical handling and also spectroscopic analysis, microcapillary test systems according to the invention should be integrated into an appropriate format.

In the following examples, in which the sip-in performance of different commercially obtainable GC microcapillary columns was tested, the microcapillaries used were about 1 cm long microcapillary column sections from Varian.

### EXAMPLES

### Example 1

### Sip-in Performance of GC Microcapillary Columns Having Different Internal Coatings (Stationary Phases)

An approximately 1 cm microcapillary section of each of the following column types from Varian was used:

CP-Sil 5 CB: stationary phase: 100% dimethylpolysiloxane

CP-Wax 52 CB: stationary phase: polyethylene glycol

CP-Wax 52 CB: stationary phase: cyanopropylpolysiloxane

The test liquid used was a Glucometer ENCORE™ glucose control solution which is customarily used as a blood replacement for checking glucose test strips.

The following aspiration results were obtained:

CP-Sil 5 CB: the test liquid was not sip ind.

CP-Wax 52 CB: the test liquid was sip ind within a few seconds.

CP-Wax 52 CB: the test liquid was sip ind within a few seconds.

### Example 2

### Surfactant Coating of a Hydrophobic GC Microcapillary Column

The GC microcapillary column having a hydrophobic stationary phase (CP-Sil 5 CB, Varian), which as mentioned in Example 1 did not sip in the sample liquid, was coated with a surfactant as follows:

Surfactant solution: 1% solution of phospholipon 90 G (Rhone-Poulenc) in isopropanol.

An approx. 1 cm CP-Sil 5 CB microcapillary column was coated under reduced pressure with the surfactant solution and then dried (dynamic coating, see K. Grob: Making and Manipulating Capillary Columns for Gas Chromatography).

Sip-in test using ENCORE™ control solution: a 2 cm microcapillary column section was filled in less than 1 sec.

1. Method for qualitative and/or quantitative determination of one or more analytes in a sample, said method comprising subjecting said sample taken up by a microcapillary to at least one spectroscopic method to give a qualitative and/or quantitative determination of said one or more analytes in said sample.

2. Method according to claim 1, wherein the microcapillary has a coating on its inner surface.

3. Method according to claim 1, which is carried out to determine glucose in blood or interstitial tissue fluid.

4. Method according to claim 1, wherein the microcapillary comprises glass or quartz.

5. Method according to claim 1, wherein the internal diameter of the microcapillary is 500 μm or less.

6. Method according to claim 1, wherein said spectroscopic method is infrared or Raman spectroscopy.

7. Test system for qualitative and/or quantitative determination of one or more analytes in a liquid sample wherein the sample is taken up by a microcapillary and the analyte or analytes are determined by a spectroscopic method.

8. Test system according to claim 7, wherein the analyte or analytes are determined in the microcapillary.

9. Test system according to claim 7, wherein the sample volume to be taken up by the microcapillary is smaller than 3 μl.

10. Test system according to claim 7, wherein the analyte or analytes are determined by infrared or Raman spectroscopy.
